(19) United States
(12) Patent Application Publication
(10) Pub. No.: US 2003/0228059 A1
(43) Pub. Date: Dec. 11, 2003

(54) Data collator for a plurality of asynchronous/synchronous data generation entities

(76) Inventors: Atul Khanduri, Gurgaon (IN); Sandip Ranjhan, Gurgaon (IN); Ajit Singh, Gurgaon (IN)

Correspondence Address: NIXON & VANDERHYE P.C., 8th Floor, 1100 North Glebe Road, Arlington, VA, 22201, US

(21) Appl. No.: 10/162,690

(22) Filed: Jun. 6, 2002

(51) Int. Cl. G06K 9/68

(52) U.S. Cl. 382/218

(57) ABSTRACT

The present invention relates to a data collator useful in a scenario where multiple entities/applications, which are unaware of the data processing of each other, want to collate their data before passing it to the external entity. Each entity informs the data collator about its dependency for a given common reference value on other entities in the system while storing the data generated with the data collator. The data generated and the dependency data form an input stream into the data collator which then stores the data generated while verifying the dependencies. The data collator then delivers the complete generated data values as a bunch to the internal/external receiving/requesting entity when the required dependencies are satisfied. Thus, a complete match is attained before the data generated is transmitted to the receiving/requesting addressee by the data collator.

### FIELD OF THE INVENTION

The present invention relates to a data collator for a plurality of asynchronous/synchronous data generation entities and to a method of data collation thereof.

### BACKGROUND OF THE INVENTION

Data generation systems (such as for example, high availability systems such as IP telephony, packaging and billing systems, utility measurement and billing systems) comprise a plurality of data generation entities.

Each of the data generation entities belongs to a system wherein each entity generates data, that is randomly distributed in time and sequence, and is related to data from other entities through a common reference value and as such requires collation and check for system wide completeness before further processing/storage.

For example, in packaging systems, the data generated by each collection and weight measurement unit would generally comprise a specific weight value, the indication of contents, and their respective amounts in the article being weighed. In Internet Web Page data retrieval systems, the data generation entity would be the Web page and the data would include the Web Page contents and hyperlink Web addresses relevant to a particular search term. The data generated by a set of entities requires collation, checking for completeness with reference to a stipulated common reference element before being handed over to a entity for further processing or storage.

Chinese patent CN 1226025 discloses a method for data collation wherein the array skewing collator includes m lines of comparators, each line possesses n comparators to form n×m array of comparators. Each comparator has a first input end, a second input end and an output end, and all first input ends of comparators being in each line are connected together, and all data of first group data string are respectively connected to the first input ends, and the second group data string is connected to the second input end in the mode of that each line is skewed at one bit. This device can be used to implement quick multi-character comparison so as to accelerate the inquiry operation of characters.

Where numerous independent asynchronous/synchronous data generation entities constitute a system, there is a frequent requirement that the data of the sets of entities be collated together for a given common reference element and be checked for completeness before it is handed over to external entity. However, most data generation systems face a significant problem since the data generated by the various entities can be randomly distributed in the time and sequence domain and also the criteria for completeness of data set is variable and based on extraneous factors which are determinable only at runtime. For example, in some systems, data from two entities is adequate to meet the completeness requirement, while other data generations systems require data from all the data generation entities to be collated before the completeness requirement is met. An additional disadvantage is that each entity is capable of determining only whether the immediately preceding or succeeding entity data is absolutely required, for matching that particular entity's completeness criterion for a given common reference element. This results in different definitions of completeness in different systems and even within the same system depending on the data generated by different entities at different points of time.

As a result, it is not been possible hitherto to implement a generic algorithm that is capable of intuitively determining the completeness of data received whether based on time or sequence or the number of entities involved. It is therefore essential to provide a heuristic solution for resolving the problem of data collation in systems which generate asynchronous data whether in time domain or from different data generation entities which is capable of accommodating the differing definitions of completeness of data while providing the desired result.

### OBJECTS OF THE INVENTION

Accordingly, the main object of the present invention is to provide a data collator for a system comprising a plurality of data generation entities which generate asynchronous/synchronous data.

It is another object of the invention to provide a method for data collation involving a heuristic method of data collation capable of accommodating variations in definitions of completeness in the time/sequence frame and from different data generation entities.

It is another object of the invention to provide a data collation method capable of utilising a dependency check method in order to generate completeness information and transmit the completed data forward to an internal/external requesting or receiving system as a bundle but with each data unit being capable of being accessed independently.

It is yet another object of the present invention to provide a data collation method that is versatile, effective, economical and reliable.

### SUMMARY OF THE INVENTION

The above and other objects of the invention are achieved by the data collation method of the invention, which involves a highly optimised manner of data collation using a dependency tree method.

Accordingly, the present invention relates to a data collation method for a asynchronous/synchronous data generation system comprising a plurality of asynchronous/synchronous data generation entities, each entity generating two data sets one comprising dependency data with respect to data generated for same reference value by other entities in the system, and the other data set comprising the reference value linked entity generated user data forwarded to an addressee receiving/requesting system either in response to a request or sent unsolicited and in reference to a system reference value stored in the said data collator, wherein the data sets generated by each entity are input into the data collator, said data collator storing all the respective reference value linked user data sets generated by each data generation entity and carrying out a matching dependency check, said data collator forwarding said reference value linked user data sets to the requesting/receiving addressee system once the dependencies are satisfied.

In one embodiment of the invention, each data generation entity creates a dependency data set for the immediately preceding data generation entity.

In another embodiment of the invention, each data generation entity creates a dependency data set for the immediately succeeding data generation entity.

In yet another embodiment of the invention, each data generation entity creates a dependency data set for the immediately preceding and immediately succeeding data generation entity.

In a further embodiment of the invention, each data generation entity creates a dependency data set for one or more randomly preceding or succeeding data generation entities.

In another embodiment of the invention, the reference value linked user data generated by each data generation entity comprises asynchronous/synchronous data.

In another embodiment of the invention, the data collator stores the reference value linked user data generated by each data generation entity subsequent to the transmittal of the matching data to the requesting/receiving addressee system.

In a further embodiment of the invention, the data stored is maintained till specific deletion commands are fed to the data collator by the data generating system.

In a further embodiment of the invention, the data stored is maintained till specific duration if all the dependencies are not met.

### BRIEF DESCRIPTION OF THE ACCOMPANYING DRAWINGS

FIG. 1 is a schematic representation of the usage scenario of the data collator of the invention in a high availability platform.

FIG. 2 is a schematic representation of a dependency web of a system involving a plurality of asynchronous data generation entities in a data generation system.

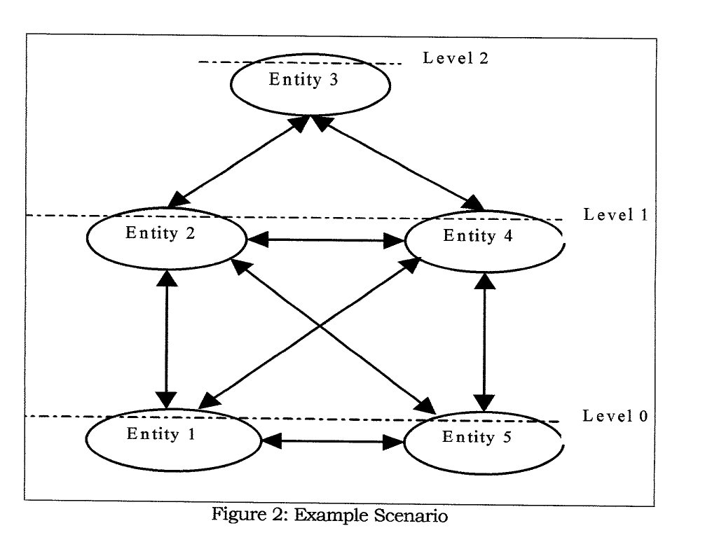

### DETAILED DESCRIPTION OF THE INVENTION

The data collator (DC) is responsible for collating data from numerous asynchronous/synchronous data generation entities, for a given common reference element, and conducting dependency check on it to ensure that all the data that is required for completeness is available before being handed over to internal/external receiving/requesting entity (addressee) as a bundled, but independently accessible, data for further action.

The data collation method of the invention has particular utility in situations where it is known at run time as to for a particular entity for which succeeding or preceding entities data needs to be collated together, but what is not known at individual entity level is whether the succeeding or preceding entities have further dependencies on other entities and when (distribution in time) or in what sequence the required entities would generate their data.

The data collator of the invention is capable of use in a scenario where multiple entities/applications, which are unaware of the data processing of each other, want to collate their data before passing it to the external entity. Each entity informs the data collator about its dependency for a given common reference value on other entities in the system while storing the data generated with the data collator. The data generated and the dependency data form an input stream into the data collator which then stores the data generated while verifying the dependencies. The data collator then delivers the whole generated data values as a bunch to the internal/external receiving/requesting entity when the required dependencies are satisfied. Thus, a complete match is attained before the data generated is transmitted to the receiving/requesting addressee by the data collator.

The invention will now be explained with reference to the accompanying drawings, which are illustrative of the schematics of the invented data collation method and should not be construed as limiting the scope of the invention in any manner.

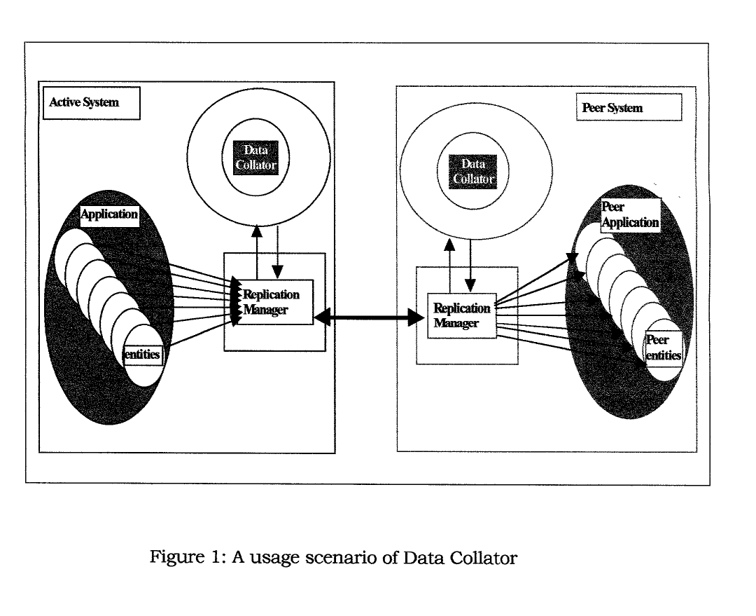

FIG. 1 is a schematic representation of the usage scenario of the data collator of the invention in a high availability platform where multiple entities of an application desire to replicate their data to peer entities once data is received from a group of entities.

The active system (1) comprises a set of data generation entities (2), each of which are unaware of the data generation operation of the other entities in the system. The requesting addressee system (11) creates a request for a set of data or the data is sent unsolicited. For the requested/sent data, the replication manager (13) of the active system (11) creates a reference element which is then input into the data collator (14) and the replication manager (3) of the active system (1). The input data stream from each data generation entity (2) in the active system (1) either in answer to the request or generated unsolicited, is transmitted along with respective dependency data to the data collator (4) of the active system (1). The data collator (4) then carries out a dependency check using a dependency tree mechanism and transmits only such data as is relevant when all dependencies are satisfied to its replication manager (3) which then inputs this result as a bunched but independently accessible data stream to the replication manager (13) of the requesting/receiving addressee system (11).

The data collator (4) can also act as storage for information sent out from one system to internal/external entities. The entities while sending request to data collator can choose whether they want to keep a copy of the data on data collator or not after dependencies are satisfied. If the entities choose not to keep the data after dependencies are met, the data will be deleted from the data collator and only one reference for that transaction will be kept till the delete request is received for that transaction. If the entities opt to keep the data, a copy of the data will be retained at data collator till the invoking entity explicitly asks for its deletion. This can be well applied in telecommunication applications where the generation of CDR and Call related traces present a challenging scenario. All the data needs to be collated for a particular call from various entities present in the same or different network devices in the memory of collating system and then sent to the disk storage once all the dependencies are met. The data collator can act as the collating agency and once the dependencies are met the data can be shifted to the hard disk.

With reference to FIG. 1 the data collator collates the data received from various entities and hands it over to replication manager, which replicates it to the peer system to keep its data in synch with the active system.

Some of the situations where the data collator of the invention and the data collation method of the invention are useful are collating data and writing it into a disk when all the required dependencies of a transaction are met. Another situation is where a fire alarm has to be raised only when a set of dependent smoke detectors detects the fire. Each smoke detector on various floors can be assigned a level, and in case of fire they can inform data collator of the fire alarm event. The data collator checks the required dependencies for the fire alarm event from the set of smoke detectors are received or not, and raises the fire alarm when all required dependencies are satisfied.

Generally the data collation method of the invention, can also be used in any application where the configuration commands is given to ‘n’ number of entities that have a hierarchical dependency between them which is unknown to commanding entity. The configuration command is applied only if all the dependent entities respond with a positive acknowledgement. In case any one of the dependent entities sends a negative acknowledgement and the command is rolled back.

Dependency Checking Algorithm of Data Collator

As explained above, each entity sends their request for data collation to the data collator along with the required dependencies the data collator keeps track of the dependencies and once dependencies are satisfied, hands over the data to the external entity.

FIG. 3 is a schematic representation of the dependencies of an asynchronous data generation system. In the figure as shown the five entities need a dependency check before delivering the data to the external entity. Each entity is identified in the data collator by a predefined level, which is a logical identification of the entity within the data collator. The arrows show the dependencies of each entity on the other entities in the system.

Entity 1 sends data to the data collator (not shown) for dependency check. Entity 1 informs the data collator that it is dependent on two level 1 entities and one level 0 entity and sends the required information as:

| Dependency Check | True |
|---|---|
| Transaction ID | 1 (Unique Integer) |
| Module ID | Entity 1 |
| Action Command | Store |
| Dependency level | 0 |
| Required | Level 0 = 1 |
| Dependencies | Level 1 = 2 |
| | Level 2 = 0 |

The data collator on receiving the request, finds the request is for storing the data and for dependency checking. The data collator then stores the data in its memory pool and initializes the dependency table for the transaction. Data collator then calculates the weightage of the sending entity 1 by summing all the required dependencies. In the dependency table data collator maintains count of the dependencies of each level. Data collator increments the count of the dependencies of each level by the given required dependencies and decrements the count of the dependencies of the level (level of the sending entity) by the weightage of the sending entity.

After modifying the dependencies the data collator checks the dependencies level count. If all the counts are zero, the data collator hands over the complete data generated by entity 1 for that transaction to the external entity.

In case of Entity 1 the weightage of the entity is 3 (2+1+0). As a result, after receiving the request from entity 1, the dependencies count of the transaction in the data collator table for entity 1 is:

| Transaction | Dependency Count | | |
|---|---|---|---|
| ID | Level 0 | Level 1 | Level 2 |
| 1 | −2 (−3 + 1) | 2 | 0 |

Entity 2 sends its request to the data collator on similar lines as for entity 1 along with the following parameters:

| Dependency Check | True |
|---|---|
| Transaction ID | 1 (Unique Integer) |
| Module ID | Entity 2 |
| Action Command | Store |
| Dependency level | 1 |
| Required | Level 0 = 2 |
| Dependencies | Level 1 = 1 |
| | Level 2 = 1 |

The weightage of the entity 2 is 4 (2+1+1). After processing the entity 2 request the dependencies count of the transaction in data collator for entity 2 is:

| Transaction | Dependency Count | | |
|---|---|---|---|
| ID | Level 0 | Level 1 | Level 2 |
| 1 | 0 (−2 + 2) | −1 (2 − 4 + 1) | +1 |

Entity 3 also sends its request to the data collator as on the lines above with following parameters:

| Dependency Check | True |
|---|---|
| Transaction ID | 1 (Unique Integer) |
| Module ID | Entity 3 |
| Action Command | Store |
| Dependency level | 2 |
| Required | Level 0 = 0 |
| Dependencies | Level 1 = 2 |
| | Level 2 = 0 |

The weightage of the entity 3 is 2. After processing the entity 3 request the dependencies count of the transaction in the data collator for entity 3 is:

| Transaction | Dependency Count | | |
|---|---|---|---|
| ID | Level 0 | Level 1 | Level 2 |
| 1 | 0 | +1 (−1 + 2) | −1 (1 − 2) |

Entity 4 sends its request to the data collator on similar lines as for entities 1, 2 and 3 but with following parameters:

| Dependency Check | True |
|---|---|
| Transaction ID | 1 (Unique Integer) |
| Module ID | Entity 4 |
| Action Command | Store |
| Dependency level | 1 |
| Required | Level 0 = 2 |
| Dependencies | Level 1 = 1 |
| | Level 2 = 1 |

The weightage of the entity 4 is 4 (2+1+1). After processing the entity 4 request the dependencies count of the transaction in data collator for entity 4 is:

| Transaction | Dependency Count | | |
|---|---|---|---|
| ID | Level 0 | Level 1 | Level 2 |
| 1 | 2 (0 + 2) | −2 (1 − 4 + 1) | 0 (−1 + 1) |

Entity 5 sends its request also on similar lines as above to data collator with the following parameters:

| Dependency Check | True |
|---|---|
| Transaction ID | 1 (Unique Integer) |
| Module ID | Entity 5 |
| Action Command | Store |
| Dependency level | 0 |
| Required | Level 0 = 1 |
| Dependencies | Level 2 = 2 |
| | Level 2 = 0 |

The weight-age of the entity 5 request is 3 (1+2+0). After processing the entity 5 request the dependencies count of the transaction in data collator for entity 5 is:

| Transaction | Dependency Count | | |
|---|---|---|---|
| ID | Level 0 | Level 1 | Level 2 |
| 1 | 0 (2 − 3 + 1) | 0 (−2 + 2) | 0 |

The data collator then determines whether all the required dependencies are satisfied. All dependencies are satisfied if the dependencies count of all levels became zero. The data bundle is then transmitted to the external requesting/addressee entity.

We claim:

1. A data collation method for a asynchronous/synchronous data generation system comprising a plurality of asynchronous/synchronous data generation entities, each entity generating two data sets one comprising dependency data of the entity with respect to other entities in the system and the other data set comprising the a reference value linked data either in response to a request by an addressee requesting system or generated unsolicited to a receiving system and in reference to a system reference value stored in the data collator, wherein the data sets generated by each entity are input into the data collator, said data collator storing all the respective reference value linked data sets generated by each data generation entity and carrying out a matching dependency check, said data collator forwarding said reference value linked data sets to the requesting/receiving addressee system once the dependencies are satisfied.

2. A data collation method as claimed in claim 1 wherein each data generation entity creates a dependency data set for the immediately preceding data generation entity.

3. A data collation method as claimed in claim 1 wherein each data generation entity creates a dependency data set for the immediately succeeding data generation entity.

4. A data collation method as claimed in claim 1 wherein each data generation entity creates a dependency data set for the immediately preceding and immediately succeeding data generation entity.

5. A data collation method as claimed in claim 1 wherein each data generation entity creates a dependency data set for one or more randomly preceding or succeeding data generation entities.

6. A data collation method as claimed in claim 1 wherein the reference answer data generated by each data generation entity comprises asynchronous/synchronous data.

7. A data collation method as claimed in claim 1 wherein the data collator stores the reference value linked data generated by each data generation entity subsequent to the transmittal of the matching data to the requesting/receiving addressee system.

8. A data collation method as claimed in claim 1 wherein the data stored is maintained till specific deletion commands are fed to the data collator by the requesting/receiving addressee system.

9. A data collation method as claimed in claim 1 wherein each entity is assigned a predetermined reference level by the data collator for the purpose of data dependency matching.

10. A data collation method as claimed in claim 1 wherein the data generation entities comprise a high availability system.

11. A data collation method as claimed in claim 1 wherein the data generation entities comprise a fire alarm system.

12. A data collation method as claimed in claim 1 wherein the data generation entities comprise a CDR collation system.

13. A data collation method as claimed in claim 1 wherein the data generation entities comprise a Transaction related data collation system.

14. A data collation method as claimed in claim 1 wherein the data generation entities comprise a Network Management Command, configuration and alarm collation system.

15. A data collation method as claimed in claim 1 wherein the data generation entities comprise a Web based data collation system where dependencies on each hyper link till the last web page need to be resolved before data can be deemed complete.
